(19) United States
(12) Patent Application Publication
(10) Pub. No.: US 2013/0050106 A1
(43) Pub. Date: Feb. 28, 2013

(54) METHOD FOR RECOGNIZING MOTION PATTERN AND THE APPARATUS FOR THE SAME

(71) Applicants: Yon Dohn CHUNG, Seoul (KR); Da Hee JEONG, Seoul (KR); Hyun Sik CHOI, Seoul (KR)

(72) Inventors: Yon Dohn CHUNG, Seoul (KR); Da Hee JEONG, Seoul (KR); Hyun Sik CHOI, Seoul (KR)

(73) Assignee: KOREA UNIVERSITY RESEARCH AND BUSINESS FOUNDATION, Seoul (KR)

(21) Appl. No.: 13/419,016

(22) Filed: Mar. 13, 2012

(30) Foreign Application Priority Data
Aug. 22, 2011 (KR) 10-2011-0083693

(51) Int. Cl. G06F 3/041

(52) U.S. Cl. 345/173

(57) ABSTRACT

The present invention relates to a method and apparatus for recognizing a motion pattern formed by a continued contact surface. A method for recognizing a motion patter according to an embodiment of the invention may comprise receiving a motion pattern as input from a user, comparing pattern information of the motion pattern with pattern information of a preset release pattern, and determining a mismatch level of the motion pattern according to the comparison result. According to an embodiment of the invention, if an inputted motion pattern does not match the preset release pattern, the degree of mismatch is determined with different levels, to respond in various ways other than simply maintaining the locked state.

### CROSS-REFERENCE TO RELATED APPLICATIONS

This application claims the benefit of Korean Patent Application No. 10-2011-0083693, filed with the Korean Intellectual Property Office on Aug. 22, 2011, the disclosure of which is incorporated herein by reference in its entirety.

### BACKGROUND

1. Technical Field

The present invention relates to a pattern recognition method and apparatus, more particularly to a method and apparatus for recognizing a motion pattern formed by a movement along a contact surface.

2. Description of the Related Art

Digital devices such as digital door locks, digital safes, digital TVs, etc., and mobile devices such as cell phones include a digital locking apparatus for preventing theft of private information and restricting the use of the device.

Methods for releasing the locking apparatus of a mobile device employ not only inputting a number password on a numerical keypad but also having the user touch the input unit implemented on a touchscreen, etc., to form a contact surface and forming a pattern by movement without breaking the contact surface.

A prior patent application filed in Korea entitled “Apparatus for unlocking of mobile device using pattern recognition and method thereof” (KR 10-2007-0125669, filed Dec. 5, 2007) discloses an invention in which a pattern inputted by touch on an LCD unit is recognized and compared with a preset pattern, and if the input pattern is determined to be the same as the set pattern, power is supplied to the LCD unit to enable use of the device.

However, just as the invention in the prior patent application (KR 10-2007-0125669) involves supplying the power and enabling use of the device only if the pattern inputted by the user is the same as the preset pattern, the prior art only presupposes the two consequences of the pattern inputted by the user matching or not matching the preset pattern.

As a result, there are disadvantages in security and convenience as the same degree of locking for the locking apparatus apply when the user inputs a pattern that does not match the preset pattern in the user's own mobile device by mistake and when some person inputs an unmatching pattern while attempting to access a stolen mobile device.

### SUMMARY

An aspect of the invention is to provide a pattern recognition method and apparatus where, if a motion pattern inputted to release the locking apparatus of a digital device does not match the preset pattern, the degree of mismatch is determined from among different levels, to respond in various ways other than simply maintaining the locked state.

The objectives of the present invention are not limited to the objective above. Other objectives and advantages of the present invention will be understood from the descriptions that follow and will be more clearly understood from the embodiments of the invention. Also, it should be readily appreciated that the objectives and advantages of the present invention can be realized by the means disclosed in the claims and combinations thereof.

To achieve such objectives, an aspect of the present invention may comprise receiving a motion pattern as input from a user, comparing pattern information of the motion pattern with pattern information of a preset release pattern, and determining a mismatch level of the motion pattern according to the comparison result.

Another aspect of the present invention may comprise an input unit configured to receive a motion pattern as input from a user, a comparator unit configured to compare pattern information of the motion pattern with pattern information of a preset release pattern, and a determiner unit configured to determine a mismatch level of the motion pattern according to the comparison result.

### BRIEF DESCRIPTION OF THE DRAWINGS

FIG. 1 is a diagram of an apparatus for recognizing motion pattern according to an embodiment of the present invention.

FIG. 2 is a drawing for illustrating the input unit from among the components of an apparatus for recognizing motion pattern according to an embodiment of the present invention.

FIG. 3 illustrates the pseudocode of an algorithm for describing a motion pattern recognition process according to an embodiment of the present invention.

FIG. 4a through FIG. 4c are drawings for illustrating the length information, from among the information compared by the comparator unit of an apparatus for recognizing motion pattern according to an embodiment of the present invention.

FIG. 5a through FIG. 5f are drawings for illustrating the coordinate information, from among the information compared by the comparator unit of an apparatus for recognizing motion pattern according to an embodiment of the present invention.

FIG. 6a through FIG. 6e are drawings for illustrating the shape information, from among the information compared by the comparator unit of an apparatus for recognizing motion pattern according to an embodiment of the present invention.

FIG. 7a and FIG. 7d are drawings for illustrating the shape information matrix, from among the information compared by the comparator unit of an apparatus for recognizing motion pattern according to an embodiment of the present invention.

FIG. 8a and FIG. 8b are drawings for illustrating examples in which an apparatus for recognizing motion pattern according to an embodiment of the present invention applies different mismatch levels.

FIG. 9 is a flowchart for illustrating a method for recognizing motion pattern according to an embodiment of the present invention.

FIG. 10 is a flowchart for illustrating a method for recognizing motion pattern according to another embodiment of the present invention.

FIG. 11 is a flowchart for illustrating a method of performing a particular function by using motion pattern recognition associated with an embodiment of the present invention.

### DETAILED DESCRIPTION

The objectives, features, and advantages above will be described below in more detail with reference to the accompanying drawings, such that a person having ordinary skill in the art to which the present invention pertains can readily practice the technical spirit of the present invention. In the description of the present invention, certain detailed explanations of the related art are omitted when it is deemed that they may unnecessarily obscure the essence of the present invention. Certain embodiments of the present invention will be described below in detail with reference to the accompanying drawings. In the drawings, the same reference numerals are used to represent the same of similar components.

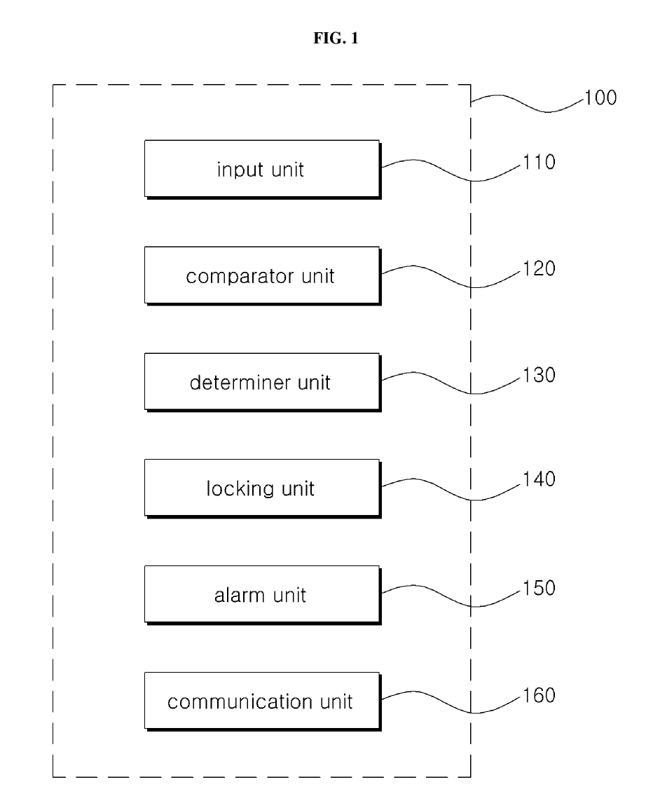

FIG. 1 is a diagram of an apparatus for recognizing motion pattern according to an embodiment of the present invention.

Referring to FIG. 1, a motion pattern recognition apparatus 100 can include an input unit 110, a comparator unit 120, a determiner unit 130, a locking unit 140, an alarm unit 150, a communication unit 160, etc. However, not all of the illustrated components are necessary essential components. The motion pattern recognition apparatus 100 can be implemented with more components than those illustrated, or can be implemented with fewer components than those illustrated.

The input unit 110 may receive a motion pattern as input from the user. For example, the input unit 110 can include a touchscreen, etc., which perceives a position and a motion pattern, when a person's hand or an object touches a character on the screen or a particular position or when the contact surface moves, and recognizes this as input data.

The comparator unit 120 may compare the pattern information of a motion pattern inputted to the input unit 110 from the user with the pattern information of a preset release pattern. A release pattern may be a pattern that serves as a password and may be preset and stored by the user. As one example of the compared pattern information, the comparator unit 120 can obtain length information of the inputted motion pattern, and then compare the obtained length information of the motion pattern with the length information of the release pattern preset by the user. As another example, the comparator unit 120 can obtain a coordinate difference value that compares each coordinate, from the specified area where the motion pattern begins to the specified area where it ends, with each coordinate of the release pattern, and then compare the obtained coordinate difference value with a preset reference difference value. In yet another example, the comparator unit 120 can compare shape information, according to the direction of movement of the motion pattern, with the shape information of the release pattern. In still another example, the comparator unit 120 can use a shape matrix, in which vectors representing the direction of movement of the motion pattern are aligned, to obtain shape information matrix values for each of the motion pattern and the release pattern, and compare the shape information matrix values of the motion pattern with the shape information matrix values of the release pattern.

Based on the result of comparing the information of the motion pattern with the information of the preset release pattern provided by the comparator unit 120 using various pattern information, the determiner unit 130 may determine the degree of mismatch for the motion pattern inputted by the user.

According to the degree of mismatch, i.e. mismatch level, determined by the determiner unit 130, the locking unit 140 can control the locking state in various ways. In the present specification, locking refers to preventing the activation of particular functions of the motion pattern recognition apparatus 100 by means of a user input (e.g. key input, touch input, etc.) and the like. For example, the locking unit 140 can release the locked state if the motion pattern matches the release pattern, and can increase the number of particular functions for which the locked state is maintained for increasingly higher mismatch levels (i.e. for increasingly greater degrees of mismatch).

The alarm unit 150 can control the output of an alarm signal based on the mismatch level determined by the determiner unit 130. The alarm signal can include at least one of an audio signal, a video signal, and a vibration. For example, the alarm unit 150 can increase the intensity of the outputted alarm signal for increasingly higher mismatch levels (i.e. for increasingly greater degrees of mismatch). This can prevent unauthorized use of the motion pattern recognition apparatus 100 by strangers.

The communication unit 160 can transmit particular information to the outside based on the mismatch level determined by the determiner unit 130. For example, in the case of the highest mismatch level (i.e. in cases where the degree of mismatch is the highest), the communication unit 160 can transmit particular information to an external server, or to a particular terminal. Cases in which the mismatch level is the highest are more likely caused by unauthorized use by strangers, not by the user of the motion pattern recognition apparatus 100. Thus, the particular information transmitted to the outside can include information that the motion pattern recognition apparatus 100 is being used without authorization. Also, if the motion pattern recognition apparatus 100 is a mobile terminal, the particular information can include position information of the mobile terminal. Also, the particular external server can include an e-mail server of the user of the motion pattern recognition apparatus 100, a server of the communication service to which the motion pattern recognition apparatus 100 is registered, and the like. The particular terminal can include a pre-designated terminal (e.g. a friend's terminal).

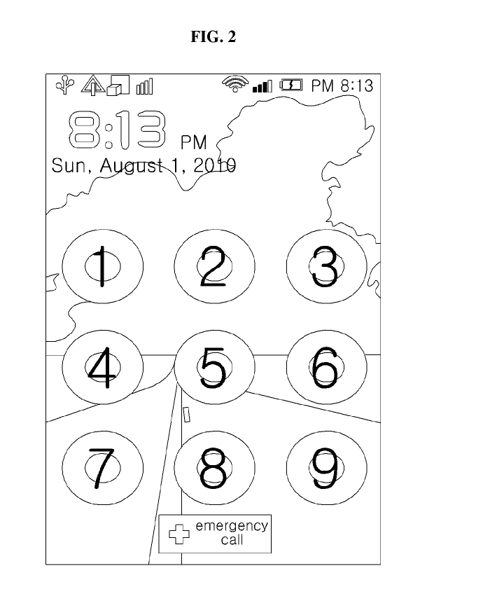

FIG. 2 is a drawing for illustrating the input unit from among the components of an apparatus for recognizing motion pattern according to an embodiment of the present invention.

FIG. 2 illustrates the initial screen of a smart phone on which a locking apparatus is operational, where specified areas are indicated on the screen. The specified areas formed as circles are arranged in three rows and three columns, where the circles are designated by numbers 1 through 9 for convenience. Here, the numbers 1 through 9 can be regarded as the coordinate values of the respective specified areas. That is, a motion pattern inputted to the input unit may be a pattern consisting of lines that arbitrarily connects the 9 areas specified on the screen, and in the descriptions that follow, motion patterns will be represented as arrows indicating a sequence of numbers and directions of movement, i.e., as vectors, for convenience.

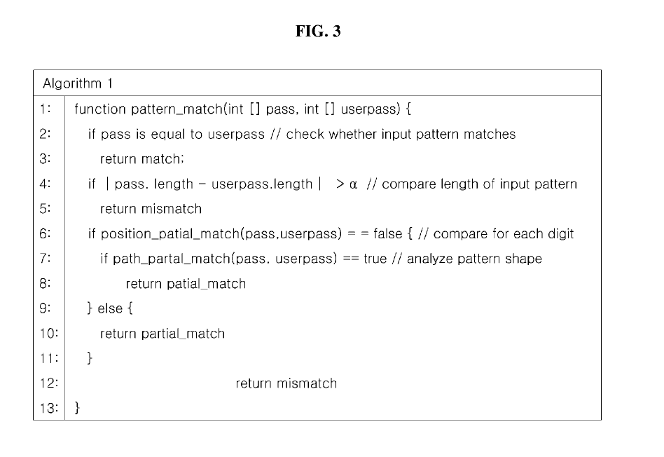

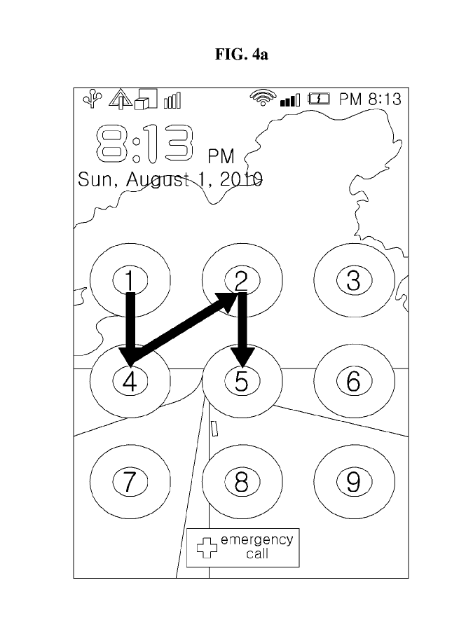

FIG. 3 illustrates the pseudocode of an algorithm for describing a motion pattern recognition process according to an embodiment of the present invention.

A process of determining a mismatch level according to the pattern information, as represented in FIG. 3, may yield three types of results: a match, where a comparison of the motion pattern inputted by the user and the preset release pattern yields a match; a partial match, where there is no match but the difference value comparing the information of the motion pattern and the information of the release pattern is smaller than a preset reference value; and a mismatch, where there is no match, and the difference value comparing the information of the motion pattern and the release pattern is greater than or equal to the reference value. That is, all of the information of the motion pattern and release pattern may be compared, and a partial match may be decided if every one of the conditions are satisfied, whereas a mismatch may be decided if even one of the conditions are not satisfied. The corresponding results after the decision of whether or not there is a match can be different for each case; one example can be to release locking for a match, maintain locking and apply a penalty for a mismatch, and maintain locking but without a penalty for a partial match. When a penalty is applied, for instance, the motion pattern recognition apparatus 100 can perform user authentication and then perform the step of comparing the release pattern with the inputted motion pattern.

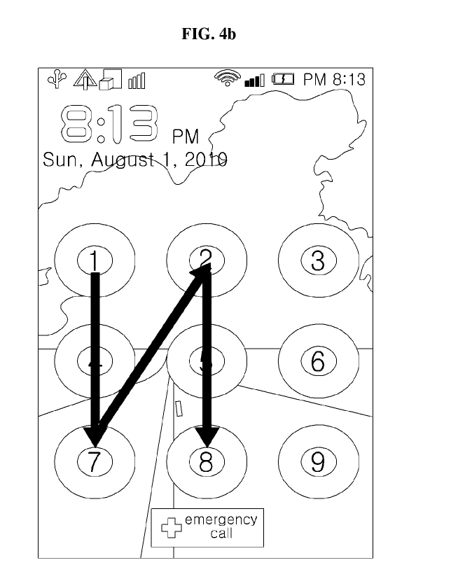

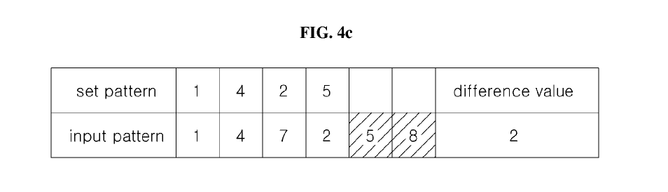

FIG. 4a through FIG. 4c are drawings for illustrating the length information, from among the information compared by the comparator unit of an apparatus for recognizing motion pattern according to an embodiment of the present invention. In the present specification, “length” may refer to the number of number pads lying within the path of a pattern.

FIG. 4a illustrates an example of a preset release pattern, FIG. 4b illustrates an example of a motion pattern inputted by the user through the input unit, and FIG. 4c illustrates the results of comparing number sequences representing the release pattern and the motion pattern.

Referring to FIGS. 4a to 4c, the length information of the motion pattern obtained at the comparator unit of the motion pattern recognition apparatus is 6, while the length information of the release pattern is 4, and therefore a difference value of ‘2’ is yielded when comparing the length information. Here, if the difference value is smaller than the preset reference value for length information, then the process proceeds to the next step of determining whether or not another condition is satisfied, and if the difference value is greater than or equal to the preset reference value, then it can be decided to classify the degree of mismatch as a high level. In this example, the reference value is set to ‘2’, and since the difference value is greater than or equal to the reference value, the degree of mismatch can be classified as a high level.

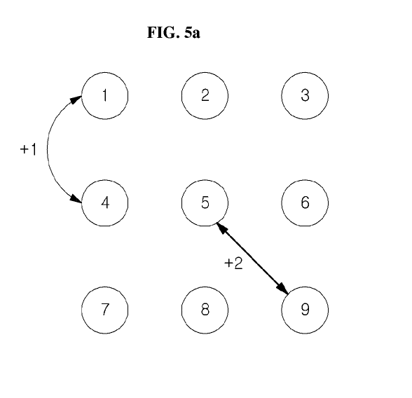

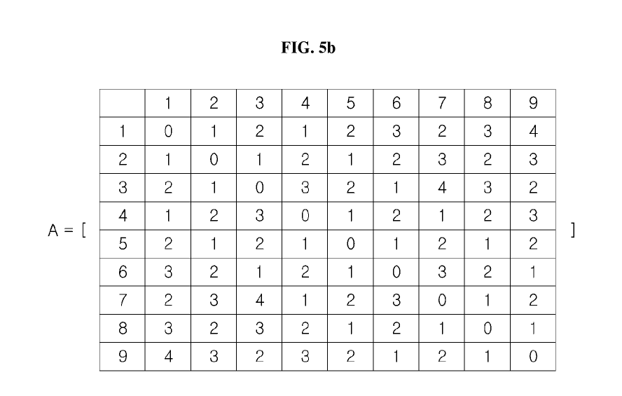

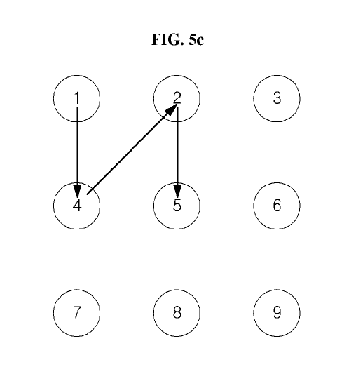

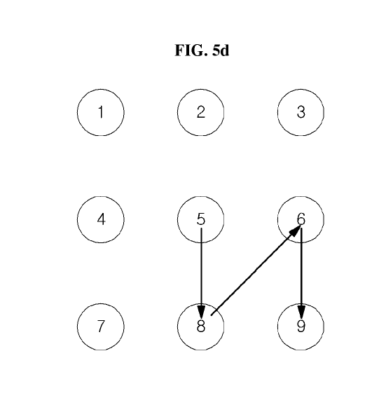

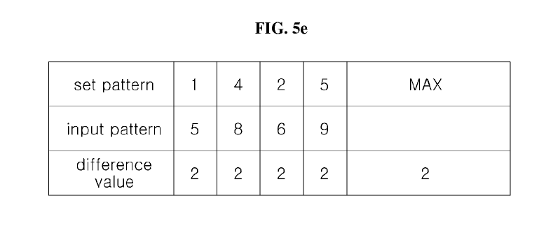

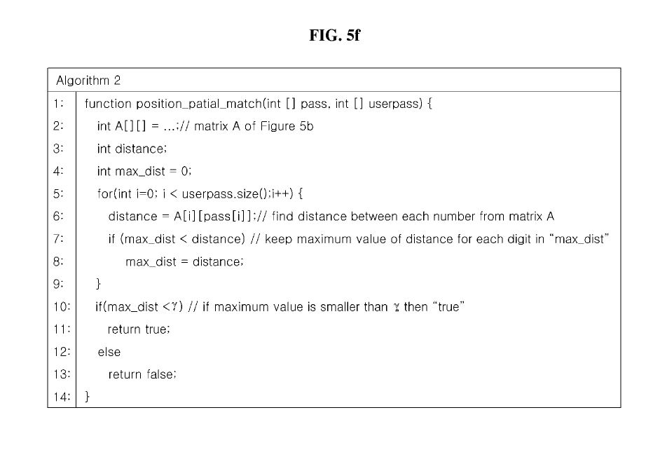

FIG. 5a through FIG. 5f are drawings for illustrating the coordinate information, from among the information compared by the comparator unit of an apparatus for recognizing motion pattern according to an embodiment of the present invention.

Referring to FIG. 5a, in calculating the distance information between the coordinates of the specified areas of the input unit, the difference value between upper, lower, left, or right areas may be calculated as ‘1’, and the difference value between diagonal areas may be calculated as ‘2’.

FIG. 5b represents the distance information between each of the coordinates as a matrix.

FIG. 5c illustrates an example of a preset release pattern, FIG. 5d illustrates an example of a motion pattern inputted by the user through the input unit, and FIG. 5e illustrates the results of comparing number sequences representing the coordinates of the release pattern and the motion pattern.

Referring to FIGS. 5c to 5e, the coordinate information of the motion pattern and the coordinate information of the release pattern may be arranged in order, and the distance information between each of the coordinates may be obtained by a method described above in FIGS. 5a and 5b. Here, the difference value is ‘2’ for each coordinate, and if the maximum difference value ‘2’ is smaller than the preset reference value, then the degree of mismatch can be classified as a low level, whereas if the maximum difference value ‘2’ is greater than or equal to the preset reference value, then the degree of mismatch can be classified as a high level.

FIG. 5f illustrates the pseudocode of an algorithm for deciding the mismatch level of a motion pattern by using the coordinate information.

Referring to FIG. 5f, using the maximum value of the distance between each coordinate of the motion pattern and the release pattern, if the maximum value is smaller than the reference value, then the process proceeds to the next step of determining whether or not another condition is satisfied, and if the maximum value is greater than or equal to the preset reference value, then it can be decided that there is a mismatch. In this example, the reference value is set to ‘2’, and since the difference value is greater than or equal to the reference value, it can be decided that there is a mismatch.

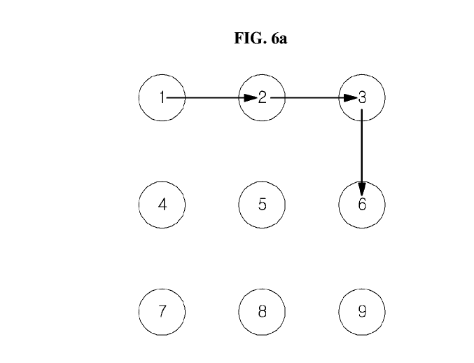

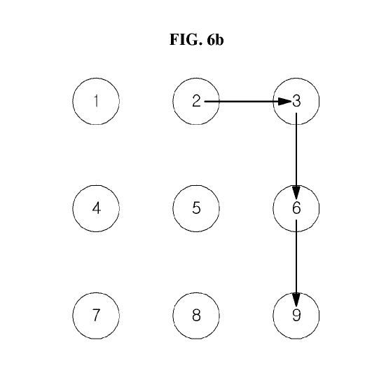

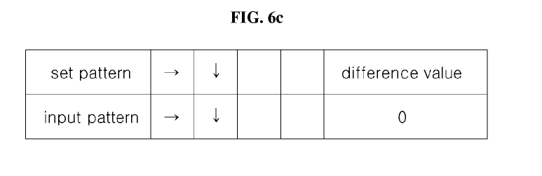

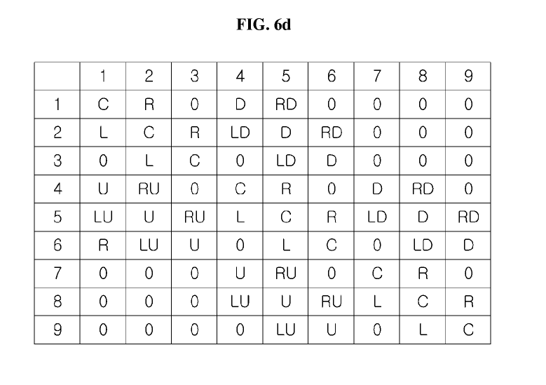

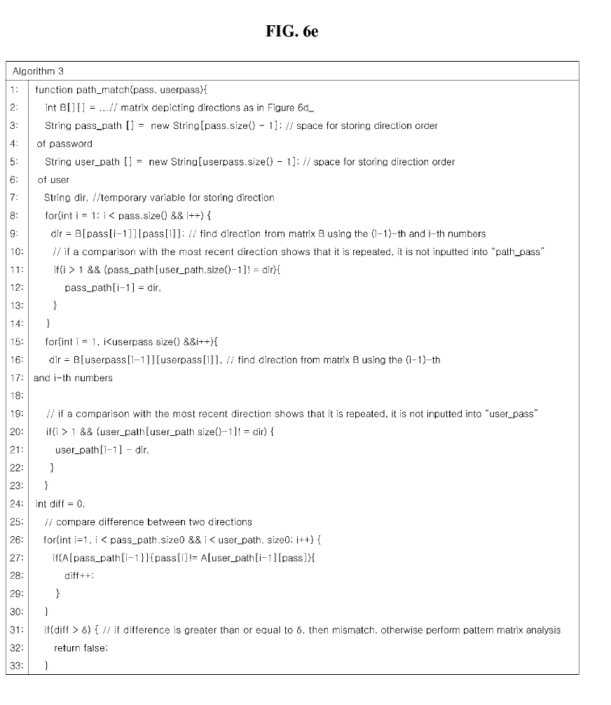

FIG. 6a through FIG. 6e are drawings for illustrating the shape information, from among the information compared by the comparator unit of an apparatus for recognizing motion pattern according to an embodiment of the present invention. In this example, a case in which the set pattern and the input pattern are different is defined as “1”, while a case in which the set pattern and the input pattern are the same is defined as “0”. The sum of the defined values may serve as the difference value. For example, if there are three occurrences of the input pattern differing from the set pattern, then the difference value of the set pattern and input pattern may be 3.

FIG. 6a illustrates an example of a preset release pattern, FIG. 6b illustrates an example of a motion pattern inputted by the user through the input unit, and FIG. 6c illustrates the results of comparing vectors which represent the direction in which the release pattern and the motion pattern progress.

Referring to FIGS. 6a to 6c, a motion pattern may be a pattern having directionality that continuously connects multiple specified areas defined in the input unit, and may therefore be represented by arrows, i.e. vectors. A fewer number of vectors are obtained than number sequences representing a pattern. Here, when the directions of continuous vectors are repeated, then the repeated vector may be omitted, to compare only the direction information of the pattern. That is, in the present example, the release pattern of FIG. 6a has the vector connecting the first area with the second area being repeated by the vector connecting the second area with the third area, so that one is omitted; while the motion patter of FIG. 6b has the vector connecting the second area with the third area being repeated by the vector connecting the third area with the fourth area, so that one is omitted. As a result, the shapes of the release pattern and the motion pattern in this example are the same, so that the difference value is ‘0’.

Referring to FIG. 6d, in order to analyze the shape information of the patterns, the sequences of two consecutive numbers can be represented as pairs of two numbers, and the pairs of numbers can be represented in rows and columns, to find the directions by looking up the value in the matrix. Here, ‘C’ means the same area, ‘R’ means the right direction, ‘L’ means the left direction, ‘RD’ means the rightward down direction, ‘RU’ means the rightward up direction, ‘LD’ means the leftward down direction, and ‘LU’ means the leftward up direction. The relationship between two numbers that are not in adjacent positions is represented by ‘0’.

FIG. 6e illustrates the pseudocode of an algorithm for deciding the mismatch level of a motion pattern by using the shape information.

Referring to FIG. 6e, the shape information of the motion pattern and release pattern may be compared to obtain a directional difference value, and if the directional difference value is smaller than the reference value, then it may be determined whether or not another condition is satisfied, whereas if it is greater than or equal to the reference value, it may be determined that there is a mismatch. In this example, the reference value is set to ‘2’, and since the difference value is smaller than the reference value, the process can proceed to the next step for deciding the mismatch level using another condition, the pattern shape matrix.

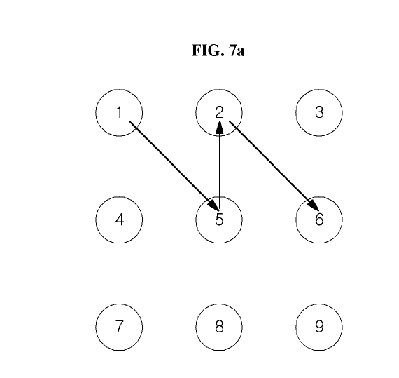

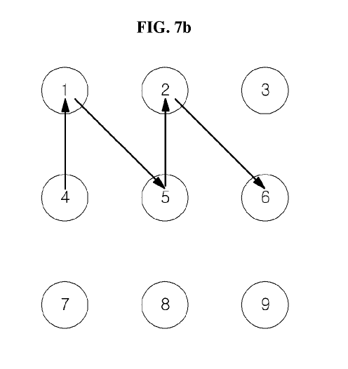

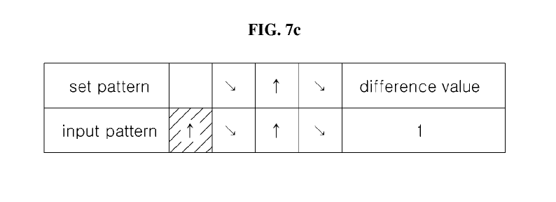

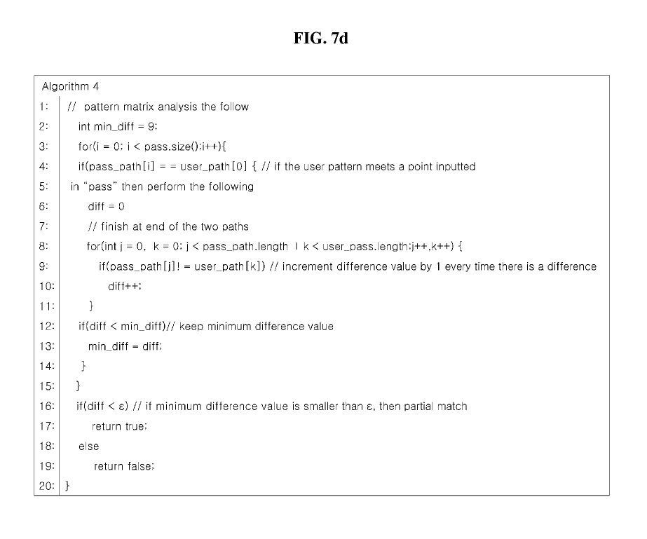

FIG. 7a through FIG. 7d are drawings for illustrating the shape information matrix, from among the information compared by the comparator unit of an apparatus for recognizing motion pattern according to an embodiment of the present invention.

FIG. 7a illustrates an example of a preset release pattern, FIG. 7b illustrates an example of a motion pattern inputted by the user through the input unit, and FIG. 7c illustrates the results of comparing vectors which represent the direction in which the release pattern and the motion pattern progress.

Referring to FIG. 7c, a shape information matrix may be obtained, arranging the vectors without omitting repeated vectors, unlike FIG. 6c. The shape information matrix values of the motion pattern thus obtained may be compared with the shape information matrix values of the release pattern. In this case, the comparison can begin at the portion where the patterns match each other. Consecutive vectors having the same direction may be regarded as the same. In this example, there is one vector's difference, so the difference value is ‘1’. Afterwards, if the difference value for the shape information matrix value is smaller than the reference value, it may be decided that there is a partial match, and if the difference value is greater than or equal to the reference value, it may be decided that there is a mismatch.

In the present example, a difference in the set pattern and the input pattern may be defined as “1”, and a sameness in the set pattern and the input pattern may be defined as “0”. The sum of the defined values may be the difference value.

In this example, since the reference value is set to ‘2’, and the difference value is smaller than the reference value, the degree of mismatch can be classified as a partial mismatch, or a low level.

FIG. 7d illustrates the pseudocode of an algorithm for deciding the mismatch level of a motion pattern by using the shape information matrix.

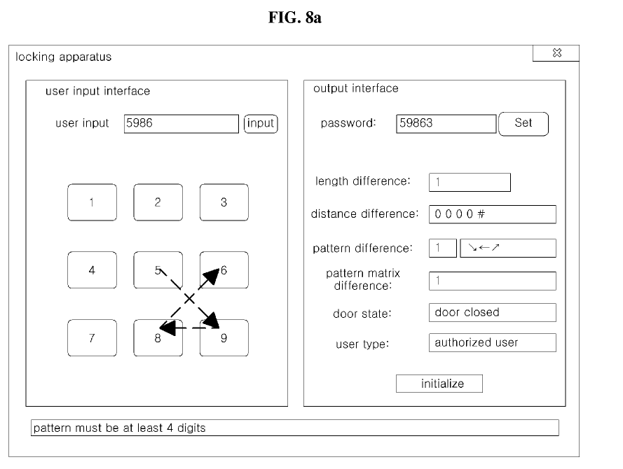

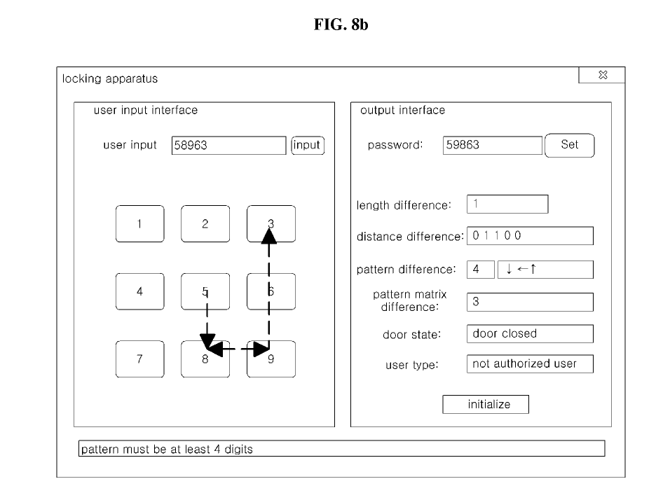

FIG. 8a and FIG. 8b are drawings for illustrating examples in which an apparatus for recognizing motion pattern according to an embodiment of the present invention applies different levels of mismatch.

FIG. 8a shows an example in which every one of the pattern information provides a value smaller than the preset reference value, resulting in a decision of a low level of mismatch, to determine the type as an authorized user.

In contrast, FIG. 8b shows an example in which one or more of the pattern information provides a value that is greater than or equal to the preset reference value, resulting in a decision of a high level of mismatch, to determine the type as an unauthorized user.

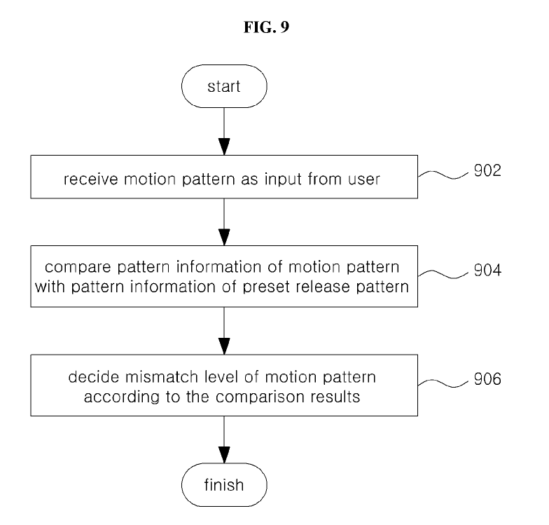

FIG. 9 is a flowchart for illustrating a method for recognizing motion pattern according to an embodiment of the present invention.

First, a motion pattern may be inputted from the user (902). Then, the pattern information of the inputted motion pattern may be compared with the pattern information of the preset release pattern (904).

Here, the pattern information comparison step (904) can include obtaining length information of the inputted motion pattern, followed by comparing the length information of the motion pattern with the length information of the release pattern.

Alternatively, the pattern information comparison step (904) can include obtaining coordinate difference values that compare the coordinates of the areas by which the motion pattern is inputted with the respective coordinates of the areas by which the release pattern is set, followed by comparing the coordinate difference value with the length information of the motion pattern with a preset reference difference value.

In another embodiment, the pattern information comparison step (904) can include comparing the shape information of the inputted motion pattern with the shape information of the release pattern.

In yet another embodiment, the pattern information comparison step (904) can use a pattern shape matrix and can include obtaining shape information matrix values of the motion pattern, followed by comparing the shape information matrix values of the motion pattern with the shape information matrix values of the release pattern.

Next, according to the results of comparing the pattern information, the mismatch level of the inputted motion pattern may be decided (906).

Here, regarding each of the examples described for the pattern information comparison step (904) as a condition, the degree of mismatch can be decided as a low mismatch level only if all of the difference values are smaller than the reference value, otherwise if even one difference value is greater than or equal to the reference value, the degree of mismatch can be decided as a high mismatch level. Also, among the cases in which all of the difference values are smaller than the reference value, that case in which all of the difference values are 0 can be decided to be the level of a complete match.

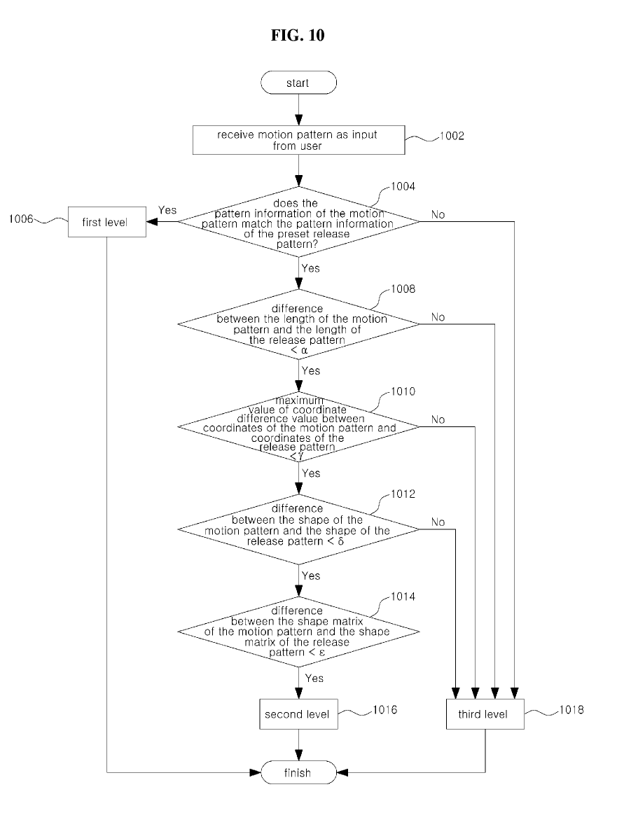

FIG. 10 is a flowchart for illustrating a method for recognizing motion pattern according to another embodiment of the present invention.

Referring to FIG. 10, when a motion pattern is inputted from the user (1002), it may be determined whether or not the motion pattern matches a preset release pattern (1004). Here, if the motion pattern completely matches the release pattern, a first level can be decided immediately, without determining other conditions (1006). The first level can be the same level as the case described for FIG. 9 in which all of the difference values are 0. If the motion pattern and the release pattern do not match, next, the length information of the motion pattern may be obtained, where if the length difference value comparing the length of the motion pattern with the length of the release pattern is smaller than a preset parameter value (α=2), the process may proceed to the next information determination step, and if the length difference value is greater than or equal to α, then a third level (1018) can be decided (1008).

If the length difference value is smaller than α, the coordinates of the motion pattern and the coordinates of the release pattern may be recognized and the coordinate difference value for each of the coordinates may be obtained, after which if the maximum value of the coordinate difference value is smaller than a preset parameter value (γ=2), the process may proceed to the next information determining step, and if the coordinate difference value is greater than or equal to γ, then a third level (1018) can be decided (1010). If the coordinate difference value is smaller than γ, then the shape of the motion pattern may be compared with the shape of the release pattern, where a vector value representing shape may be omitted if it is repeated, and afterwards, if the vector difference value is smaller than the preset parameter value (δ=2), then the process may proceed to the next information determining step, whereas if the vector difference value is greater than or equal to δ, then a third level (1018) can be decided (1012). If the vector difference value is smaller than δ, then the shape matrix values of the motion pattern may be compared with the respective shape matrix values of the release pattern, and if the difference value is smaller than the preset parameter value (ε=2), a second level can be decided (1016), or if it is greater than or equal to ε, a third level (1018) can be decided (1014).

In another embodiment of the present invention, assuming that the degree of pattern mismatch is determined by different levels as described above, if a mobile device is stolen, for example, it would be highly probable that the pattern inputted by the user will not match the preset pattern, and thus if the degree of mismatch is greater than a preset reference value, a penalty can be imposed on the user's action of inputting a pattern, such as by maintaining the locked state and shutting the power supply for a certain amount of time, etc. Conversely, if a user using his/her own mobile device mistakenly inputs a pattern that does not match the preset pattern, it would be likely that the degree of mismatch is small, and thus if the degree of mismatch is smaller than a preset reference value, the locked state can be maintained, but without imposing restrictions on the user's subsequent input. That is, the mismatch level can be varied, and a different mode can be applied according to the mismatch level, for increased security and convenience.

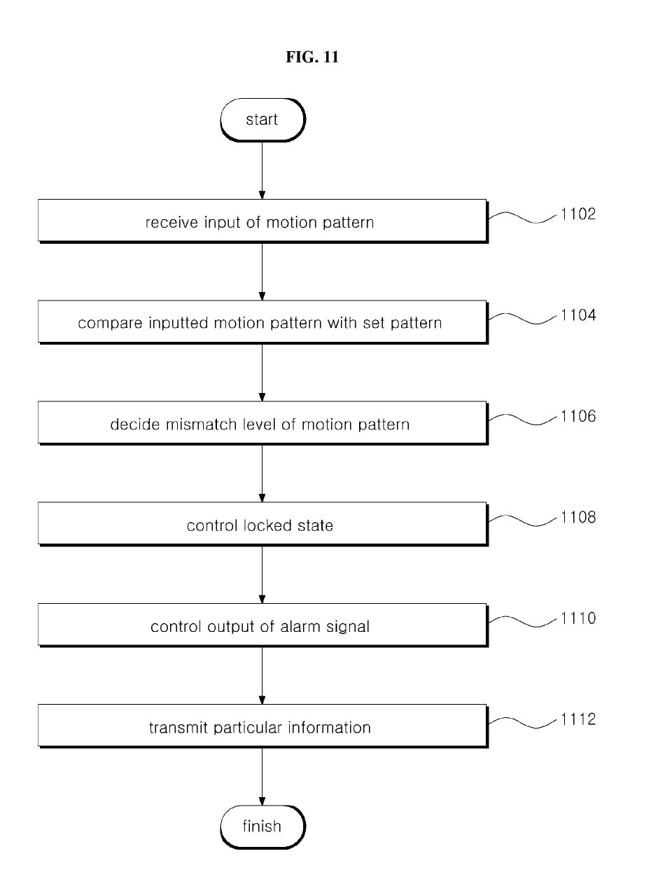

This may be illustrated in greater detail with reference to FIG. 11.

FIG. 11 is a flowchart for illustrating a method of performing a particular function by using motion pattern recognition associated with an embodiment of the present invention.

The input unit 110 may receive a motion pattern from the user (1102). Then, the comparator unit 120 may compare the inputted motion pattern with the preset release pattern (1104). As a description has already been provided as to the specific method for comparing the inputted motion pattern with the preset release pattern, it will not be provided again.

The determiner unit 130 may determine the mismatch level of the inputted motion pattern depending on the results of comparing the pattern information (1106). The mismatch level can be classified, for instance, into three types. A case in which the difference value between the motion pattern and the preset release pattern is 0 can be classified as a “match”, a case in which the difference value between the motion pattern and the preset release pattern is not 0 but is smaller than a set reference value can be classified as a “partial match”, and a case in which the difference value between the motion pattern and the preset release pattern is not 0 and is greater than or equal to the set reference value can be classified as a “mismatch”.

The locking unit 140 can control the locked state in various ways according to the degree of mismatch, i.e. mismatch level, decided by the determiner unit 130 (1108). For example, the locking unit 140 can release the locked state for a mismatch level of “match”, and can maintain the existing locked state for a mismatch level of “partial match”. Also, if the mismatch level is “mismatch”, then a locked state can be applied to other functions, in addition to the existing locked state.

The alarm unit 150 can control the output of an alarm signal based on the mismatch level decided by the determiner unit 130 (1110). For example, the alarm unit 150 can increase the intensity of the outputted warning alarm in accordance with the mismatch level (i.e. with greater degrees of mismatch). In this manner, use of the motion pattern recognition apparatus 100 by strangers can be prevented.

The communication unit 160 can transmit particular information to the outside based on the mismatch level decided by the determiner unit 130 (1112). For example, if the mismatch level is decided to be “mismatch”, the communication unit 160 can transport information related to unauthorized use of the motion pattern recognition apparatus 100 or real time position information of the motion pattern recognition apparatus 100, and the like, to the user's e-mail server, the server of a particular communication service, or to a particular terminal. By this method, one can effectively respond to misplacing the motion pattern recognition apparatus 100.

Various substitutions, variations, and modifications can be made to the present invention described above by a person having ordinary skill in the art without departing from the spirit of the invention. Thus, the present invention is not limited by the embodiments described above or by the accompanying drawings.

What is claimed is:

1. A method for recognizing a motion pattern, the method comprising:
receiving a motion pattern as input from a user;
comparing pattern information of the motion pattern with pattern information of a preset release pattern; and
determining a mismatch level of the motion pattern according to the comparison result.

2. The method of claim 1, wherein the comparing of the pattern information comprises:
obtaining length information of the motion pattern; and
comparing the length information of the motion pattern with length information of the release pattern.

3. The method of claim 1, wherein the comparing of the pattern information comprises:
obtaining a coordinate difference value between each coordinate of the motion pattern and each coordinate of the release pattern; and
comparing the coordinate difference value with a preset reference difference value.

4. The method of claim 1, wherein the comparing of the pattern information comprises:
comparing shape information of the motion pattern with shape information of the release pattern.

5. The method of claim 4, wherein the comparing of the pattern information comprises:
obtaining a shape information matrix value of the motion pattern and a shape information matrix value of the release pattern by using a motion pattern shape matrix; and
comparing the shape information matrix value of the motion pattern with the shape information matrix value of the release pattern.

6. The method of claim 1, further comprising:
controlling an output of an alarm signal based on the determined mismatch level of the motion pattern.

7. The method of claim 1, further comprising:
transmitting particular information based on the determined mismatch level of the motion pattern.

8. An apparatus for recognizing a motion pattern, the apparatus comprising:
an input unit configured to receive a motion pattern as input from a user;
a comparator unit configured to compare pattern information of the motion pattern with pattern information of a preset release pattern; and
a determiner unit configured to determine a mismatch level of the motion pattern according to the comparison result.

9. The apparatus of claim 8, wherein the comparator unit is configured to:
obtain length information of the motion pattern; and
compare the length information of the motion pattern with length information of the release pattern.

10. The apparatus of claim 8, wherein the comparator unit is configured to:
obtain a coordinate difference value between each coordinate of the motion pattern and each coordinate of the release pattern; and
compare the coordinate difference value with a preset reference difference value.

11. The apparatus of claim 8, wherein the comparator unit is configured to compare shape information of the motion pattern with shape information of the release pattern.

12. The apparatus of claim 11, wherein the comparator unit is configured to:
obtain a shape information matrix value of the motion pattern and a shape information matrix value of the release pattern by using a motion pattern shape matrix; and
compare the shape information matrix value of the motion pattern with the shape information matrix value of the release pattern.

13. The apparatus of claim 8, further comprising:
an alarm unit configured to control an output of an alarm signal based on the determined mismatch level of the motion pattern.

14. The apparatus of claim 8, further comprising:
a communication unit configured to transmit particular information based on the determined mismatch level of the motion pattern.
